(19) United States
(12) Patent Application Publication
(10) Pub. No.: US 2025/0018555 A1
(43) Pub. Date: Jan. 16, 2025

(54) Method for Manufacturing a Robotic Gripper Mimicking Human Hand Mechanics Using Multi-Material 3D Printing Technology and the Resultant Gripper

(71) Applicants: Isura Ranatunga, Concord, CA (US); Channa Ranatunga, Grand Prairie, TX (US); Sandeep Suresh, Emeryville, CA (US)

(72) Inventors: Isura Ranatunga, Concord, CA (US); Channa Ranatunga, Grand Prairie, TX (US); Sandeep Suresh, Emeryville, CA (US)

(21) Appl. No.: 18/222,452

(22) Filed: Jul. 16, 2023

(51) Int. Cl. B25J 9/00; B25J 15/00; B25J 15/12; B25J 19/02; B33Y 10/00; B33Y 80/00

(52) U.S. Cl. CPC B25J 9/0015; B25J 9/0012; B25J 15/0009; B25J 15/12; B25J 19/028; B33Y 10/00; B33Y 80/00

(57) ABSTRACT

The present invention describes a method for manufacturing a robotic gripper using multi-material 3D printing technology. The method involves creating a hard skeletal structure and soft interconnections, inserting conductive traces within these structures, threading cables through pre-designed channels, connecting these cables to the skeletal structure, forming a soft outer shell with specific indentations for sensor electronics, installing sensors and signal conditioning chips, and coating the entire assembly in a protective resin layer. The resulting robotic gripper closely replicates the mechanical properties of a human hand, demonstrating high precision and cost-effectiveness.

### FIELD OF INVENTION

The present invention relates generally to robotics, and more specifically, to a process for creating robotic end effectors or grippers that closely mimic the mechanical properties of the human hand by integrating hard, soft, and conductive materials using advanced 3D printing techniques.

### BACKGROUND

Robotic end effectors, or grippers, have been extensively used in various sectors such as manufacturing, medical, research, and service industry. Traditionally, these grippers have been designed and produced to fulfill a specific function, like picking up and placing specific parts in an assembly line, or holding surgical tools in a medical setting. However, these grippers often lack the dexterity and versatility found in the human hand, limiting their application and efficiency.

Current robotic grippers often fall short when dealing with intricate tasks that involve careful handling or require a high degree of precision, like handling delicate parts or picking and placing objects of varying shapes and sizes. The typical design of these grippers often focuses on power and stability, and less on flexibility and adaptability, making them ill-suited for tasks that require a delicate touch or complex manipulation.

In addition, current manufacturing processes for creating these grippers have a few inherent drawbacks. Traditional manufacturing methods, like injection molding, die casting, or machining, often involve expensive tooling, are labor-intensive, and are not well-suited for low-volume production runs. In addition, these techniques struggle to seamlessly integrate different types of materials into a single unit, limiting the design possibilities and the mechanical properties of the end product.

Further, the incorporation of sensors into these grippers is often a challenge. Current designs typically involve placing sensors at specific points on the gripper surface, limiting the sensing capabilities to those areas alone. This reduces the ability to achieve uniform, surface-wide sensing, which is crucial for achieving a high level of precision and versatility.

In order to overcome these limitations and to advance the state of the art, there is a need for a manufacturing process that can create robotic grippers that closely mimic the mechanical and sensing properties of the human hand. There is also a need for a cost-effective process that can seamlessly integrate different types of materials, as well as sensors, into a single structure. This will open up new possibilities in the design and application of robotic grippers, bringing them closer to the intricacy and versatility of the human hand.

It is within this context that the present invention is provided.

### SUMMARY

The present invention discloses a method for manufacturing a robotic gripper that closely replicates the mechanical properties of the human hand. The process leverages the capabilities of advanced 3D printing technology, specifically the ability to print hard, soft, and conductive materials in a single object.

The process begins by 3D printing the hard skeletal structures of the gripper using a robust material capable of maintaining structure and handling load. Simultaneously, soft interconnections are printed using a flexible material, creating structures analogous to tendons and ligaments in a human hand. These soft structures are designed to facilitate movement and dexterity, with strategically placed anchor points around the joints for subsequent cable routing and attachment.

Next, conductive traces are printed within the hard and soft materials to form the basis of the embedded electronics and sensor systems. These traces act as a network for transmitting electrical signals.

Ultra-high-molecular-weight polyethylene (UHMWPE) braided cables are then threaded through the pre-designed channels in the 3D printed structure. These cables serve as the actuation mechanism, replicating muscle function in a human hand.

Once threaded, these cables are connected to the hard skeletal structures using the previously designed anchor points, creating a secure and efficient actuation system.

A soft outer shell is then created with conductive traces and specific indentations to house sensor electronics, including force sensors and signal conditioning chips. The soft outer shell can be either 3D printed directly onto the skeletal structure or created by placing the 3D printed structure into a mold and filling it with a latex-based resin.

After the soft outer shell is formed, force sensors and signal conditioning chips are installed in the pre-formed indentations and connected to the conductive traces within the structure, completing the circuitry.

The final step of the process involves coating the entire gripper assembly in a protective resin. This creates an external layer that protects the force sensors and signal conditioning chips embedded in the soft outer shell.

In addition, the invention also discloses a robotic gripper manufactured using the aforementioned method. This gripper mimics the mechanical properties of a human hand, making it ideal for applications that require delicate handling or complex manipulation. The design and placement of sensors, chips, and other electronic components are meticulously planned to ensure they form a working circuit with the conductive traces running through the 3D printed structure, thereby allowing the gripper to have surface-wide sensing capabilities.

### BRIEF DESCRIPTION OF THE DRAWINGS

Various embodiments of the invention are disclosed in the following detailed description and accompanying drawings.

FIG. 1 is a process flow diagram illustrating the sequence of steps involved in the method of manufacturing the robotic gripper, according to an embodiment of the present invention.

FIG. 2 is a simplified diagram of a robotic gripper, shaped like a human hand, manufactured according to the method disclosed in the present invention. The index finger of the hand is shown in a cutaway view to reveal the internal components of the gripper.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terminology used herein is for the purpose of describing particular embodiments only and is not intended to be limiting.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### DESCRIPTION OF DRAWINGS

The present invention describes a method for manufacturing a robotic gripper that closely replicates the mechanical properties of a human hand by harnessing the capabilities of advanced 3D printing technology. The process incorporates hard, soft, and conductive materials into a single unit, enabling a robotic gripper that is both highly precise and cost-effective.

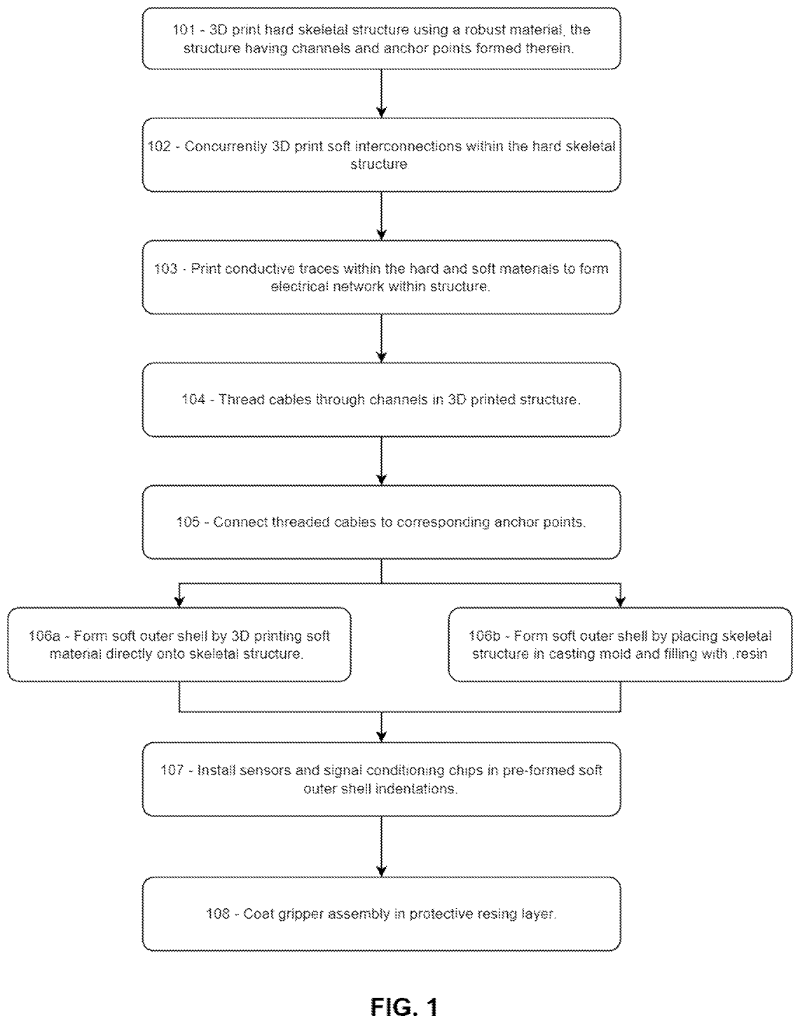

FIG. 1 is a process flow diagram illustrating the sequence of steps involved in the method of manufacturing the robotic gripper, according to an embodiment of the present invention.

Step 101 involves the 3D printing of the hard skeletal structures of the robotic gripper. In this step, a robust material such as Acrylonitrile Butadiene Styrene (ABS) or Polylactic Acid (PLA) is used to create structures that can maintain their structure under load and provide rigidity to the gripper.

Step 102 is executed concurrently with Step 101 and involves the 3D printing of soft interconnections within the hard skeletal structure. Flexible materials such as Thermoplastic Elastomers (TPE), Thermoplastic Urethane (TPU), or Polyurethane (PU) resins are used for creating these interconnections, which are designed to emulate the tendons and ligaments in a human hand.

For the present application, a suitable 3D printing technology would be Fused Deposition Modeling (FDM), also known as Fused Filament Fabrication (FFF). FDM works by feeding a continuous filament of thermoplastic material, which is then melted and extruded onto the build platform.

Step 103 involves the printing of conductive traces within the hard and soft materials. Special filaments infused with conductive materials like graphene or metal particles (such as copper or silver) are used for this purpose. These traces form the basis of the embedded electronics and sensor systems in the robotic gripper, acting as a network for transmitting electrical signals.

In Step 104, ultra-high-molecular-weight polyethylene (UHMWPE) braided cables are threaded through pre-designed channels in the 3D printed structure. These cables act as the actuation mechanism, replicating the muscle function in a human hand.

Step 105 involves connecting the threaded cables to the hard skeletal structures using previously designed anchor points.

The resulting structure would be similar in principle to the tendons in a human hand, which are pulled and relaxed to control the movements of the fingers and thumb. In the case of a robotic hand, these ‘tendons’ are represented by the high-strength UHMWPE cables running through the 3D printed structure.

Each cable would be attached to a specific finger (or thumb) and connected at the other end to a motor or servo mechanism. The motors/servos would be controlled by an embedded microcontroller unit, which would receive input from the sensor systems embedded in the gripper.

Based on this sensor feedback, the microcontroller unit would send signals to the motors/servos to pull or relax the cables. By manipulating the tension in these cables, the robotic hand can replicate different types of grips (such as a power grip or a precision grip) and movements.

For example, to form a precision grip (used for holding small objects like a pen), the microcontroller could signal the motors to pull the cables associated with the thumb and index finger, bringing them together while the remaining fingers stay relaxed. Conversely, to form a power grip (used for holding larger objects), the microcontroller could signal all the motors to pull their associated cables, closing all the fingers and thumb together.

The advantage of this cable actuation system is that it allows for highly granular control of the robotic hand, closely mimicking the nuanced movements of a human hand.

In Step 106a/b, a soft outer shell featuring conductive traces and specific indentations is created to house sensor electronics.

The soft outer shell can be either 3D printed directly onto the skeletal structure (step 106a) or created by placing the 3D printed structure into a mold and filling it with a latex-based resin (step 106b).

Step 107 includes the installation of force sensors and signal conditioning chips in the pre-formed indentations of the soft outer shell. These components are connected to the conductive traces within the structure, thereby completing the circuitry of the gripper.

The robotic hand could be embedded with several different types of sensors that each play a unique role in emulating the tactile capabilities of a human hand. For example:

Force Sensors: Also known as pressure sensors or tactile sensors, force sensors play an integral role in determining the amount of force or pressure being applied by the robotic gripper on an object. They can detect both static and dynamic pressure changes. By embedding these sensors into the fingers and palms of the robotic hand, the system can ensure that the gripper doesn't apply more force than necessary, preventing damage to objects being handled. Variations of force sensors like load cells could also be used to measure the weight of the object being held.

Proximity Sensors: These sensors can sense the presence of an object without any physical contact. By embedding proximity sensors into the robotic hand, the system can initiate actions such as opening or closing the grip when an object is near. This can be particularly useful in automated environments, allowing the hand to react to objects moving towards it on a conveyor, for example.

Temperature Sensors: These sensors detect temperature changes in the environment or the object being held. This could be crucial when handling sensitive materials that need to be kept at a certain temperature. It also adds a level of safety, alerting the system if the gripper is handling objects that are too hot or cold, potentially preventing damage to the gripper.

Hall Effect Sensors: These sensors are used to detect magnetic fields. This could be useful in situations where the gripper is handling magnetic materials or operating in environments with strong magnetic fields.

Capacitive Sensors: These sensors can be used to detect the size and shape of the object being held by the hand. They work by measuring changes in an electric field caused by the object coming into contact with the sensor.

Piezoelectric Sensors: These sensors can be used to detect vibrations or changes in pressure, acceleration, temperature, strain, or force by converting them to an electrical charge. They could be used in the robotic hand to detect subtle vibrations or texture details in the object being held.

By embedding these sensors into the robotic hand, it's possible to create a rich sensory network that can mimic the tactile sensing capabilities of a human hand. Each sensor contributes to the overall perception of the hand, providing feedback that can be used to adjust the gripper's actions and responses in real-time. This sensory information can be combined with AI algorithms to create even more sophisticated and nuanced control of the hand, getting closer to the complexity and versatility of human touch.

Signal Conditioning: Depending on the sensor, the raw signal might need to be conditioned before it can be used. This could involve amplifying the signal, filtering out noise, or converting the signal from analog to digital. Dedicated signal conditioning chips or modules may be used for this purpose. The conditioned signals are then fed into a microcontroller, which is essentially a compact computer on a single integrated circuit. It consists of a processor for computing, memory for storing data, and peripherals for interfacing with other devices.

The microcontroller runs software that processes the data coming in from the sensors, perhaps even applying machine learning algorithms to interpret the data and make decisions. For instance, it might determine that the gripper is holding an object too tightly based on the data from the force sensors, and decide to loosen the grip.

Finally, in Step 108, the entire gripper assembly is coated in a protective resin layer. This layer serves to protect the embedded force sensors and signal conditioning chips within the soft outer shell.

The present invention also describes a robotic gripper manufactured using the aforementioned method. This gripper is characterized by its ability to mimic the mechanical properties of a human hand, making it ideal for applications that require a high degree of dexterity and precision. The gripper integrates an intricate network of sensors and electronic components, thereby enabling it to sense and respond to its environment in a way that closely mirrors the human hand.

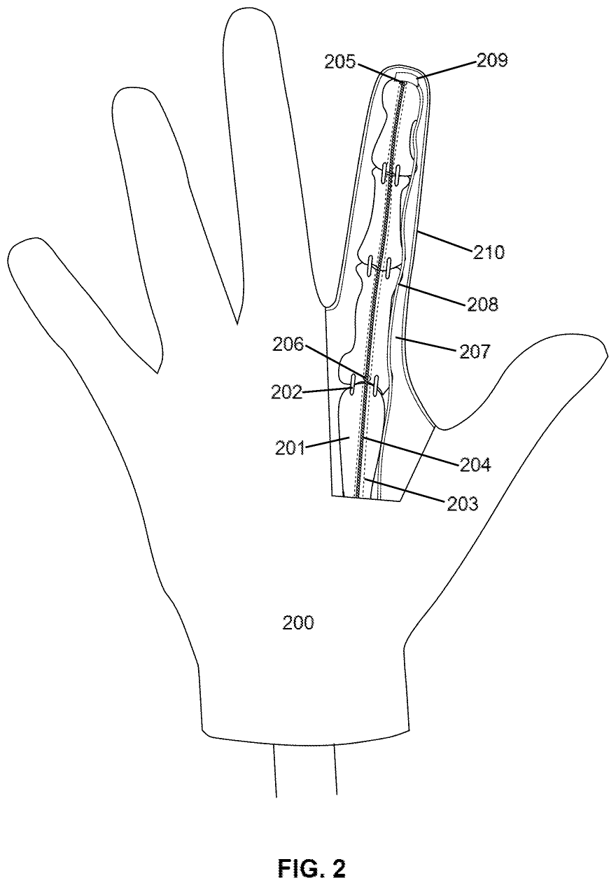

FIG. 2 is a simplified diagram of a robotic gripper, shaped like a human hand, manufactured according to the method disclosed in the present invention.

The illustrated robotic gripper (200) is designed to mimic the mechanical properties of a human hand. For clarity and illustrative purposes, the diagram presents a cutaway view of the index finger, revealing the internal components of the gripper.

At the core of the finger, as shown in FIG. 2, is the hard skeletal structure (201). This structure, made from a robust material like Acrylonitrile Butadiene Styrene (ABS) or Polylactic Acid (PLA), is designed to maintain structure and handle load. It is 3D printed to provide the necessary rigidity and durability for the robotic gripper to function effectively.

Connected to the hard skeletal structure (201) are the soft interconnections (202). These flexible structures are 3D printed using materials such as Thermoplastic Elastomers (TPE), Thermoplastic Urethane (TPU), or Polyurethane (PU) resins. They mimic the role of tendons and ligaments in a human hand, facilitating movement and dexterity of the robotic gripper.

The index finger of the robotic gripper also includes a channel (203) running through the hard skeletal structure (201) and the soft interconnections (202). This channel serves to accommodate an ultra-high-molecular-weight polyethylene (UHMWPE) braided cable (204). The cable (204) is threaded through the channel (203) and attached to the hard skeletal structure at a first anchor point (205) located on the tip of the index finger and a second anchor point (206) located on the knuckle of the index finger. The cable (204) acts as the actuation mechanism, emulating muscle function in a human hand.

Surrounding the hard skeletal structure (201) and soft interconnections (202) is a soft outer shell (207). The soft outer shell (207) is either 3D printed directly onto the skeletal structure or created by placing the 3D printed structure into a mold and filling it with a latex-based resin. This soft outer shell (207) features conductive traces (208) and specific indentations designed to house sensor electronics.

In the illustrated embodiment, a force sensor (209) is installed at the tip of the index finger, housed within the soft outer shell (207). This sensor is in contact with the conductive traces (208), enabling it to transmit sensory information, such as the force exerted by the robotic gripper.

Finally, the entire assembly, including the soft outer shell (207), is coated in a protective outer layer (210). This protective layer serves to shield the embedded components, such as the force sensor (209), and the overall structure from environmental factors and physical damage.

The design of the robotic gripper enables it to closely mimic the mechanical properties of a human hand, enhancing its versatility and effectiveness in handling complex and delicate tasks.

The robotic gripper, with its advanced capabilities, has a wide array of potential applications across different industries:

Manufacturing: In the manufacturing industry, such robotic grippers could be employed in assembly lines for picking and placing parts, handling delicate objects, or performing tasks that require high precision. Their ability to handle various objects of different sizes, shapes, and materials could make them a versatile tool on the factory floor.

Medical: In the medical field, these grippers could be used in robotic surgery systems to handle delicate tissues or surgical tools. Their sensitivity and ability to mimic human hand movements make them suitable for such precision-required tasks. They could also be used in rehabilitation devices or prosthetics, providing a more natural and intuitive interface for patients.

Research: In scientific research, these grippers could be used in labs for handling sensitive or dangerous materials, performing complex manipulations under a microscope, or even automating certain experimental processes.

Agriculture: In agriculture, these grippers could be used in automated systems for picking fruits or vegetables, where the ability to adjust grip strength and handle delicate objects could help reduce waste due to damage.

Service Industry: These grippers could also find applications in the service industry, like in restaurants for preparing food, in cleaning services for handling various equipment and objects, or in retail for stocking shelves.

### Network Components

The gripper of the present application could be operated by any suitable system or computer.

A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method of manufacture and gripper device have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for manufacturing a robotic gripper that mimics the mechanical properties of a human hand, the method comprising the steps of:
a) 3D printing a hard skeletal structure using at least a first rigid material type;
b) 3D printing soft interconnections between components of the hard skeletal structure using at least a second flexible material type, the hard skeletal structure and soft interconnections together being structured to create channels between strategically placed anchor points around the joints to allow for subsequent cable routing and attachment;
c) printing conductive traces within the hard and soft materials to form the basis of embedded electronics and sensor systems, which act as a network for transmitting electrical signals;
d) threading cables through the pre-designed channels in the 3D printed structure to act as the actuation mechanism;
e) connecting the threaded cables to the hard skeletal structures using the anchor points to create an actuation system;
f) creating a soft outer shell with conductive traces and specific indentations to house sensor electronics;
g) installing force sensors and signal conditioning chips in the pre-formed indentations of the soft outer shell and connecting them to the conductive traces within the structure to complete the circuitry; and
h) coating the entire gripper assembly in a protective resin layer to shield the embedded force sensors and signal conditioning chips.

2. The method of claim 1, wherein the cables are ultra-high-molecular-weight polyethylene (UHMWPE) braided cables.

3. The method of claim 1, wherein said soft outer shell is 3D printed directly onto the skeletal structure.

4. The method of claim 1, wherein said soft outer shell is created by placing the 3D printed structure into a mold and filling it with a latex-based resin.

5. The method of claim 1, wherein the hard skeletal structure is printed using Acrylonitrile Butadiene Styrene (ABS) or Polylactic Acid (PLA).

6. The method of claim 1, wherein the soft interconnections are printed using Thermoplastic Elastomers (TPE), Thermoplastic Urethane (TPU), or Polyurethane (PU) resins.

7. The method of claim 1, wherein the conductive traces are printed using a composite of PLA and a conductive material.

8. The method of claim 1, wherein the protective resin coating is an epoxy resin or a polyurethane coating.

9. The method of claim 1, further comprising the step of embedding a variety of sensors within the robotic hand including, but not limited to, force sensors, proximity sensors, temperature sensors, Hall Effect sensors, capacitive sensors, and piezoelectric sensors.

10. The method of claim 1, wherein the hard skeletal structure, soft interconnections, conductive traces, and soft outer shell are printed using Fused Deposition Modeling (FDM) 3D printing technology.

11. The method of claim 1, further comprising the step of operating a cable actuation system wherein the cables are manipulated by motors or servo mechanisms controlled by an embedded microcontroller unit based on input from the sensor systems embedded in the gripper.

12. The method of claim 11, wherein the microcontroller unit uses software to process data from the sensors, interpret the data, make decisions, and send signals to the motor controllers or servos.

13. A robotic gripper produced by the method of claim 1, wherein the robotic gripper mimics the mechanical properties of a human hand.
